(19) United States
(12) Patent Application Publication
(10) Pub. No.: US 2018/0116890 A1
(43) Pub. Date: May 3, 2018

(54) Disposable Bed Sheets

(71) Applicant: Sandra Grayer, Boca Raton, FL (US)

(72) Inventor: SANDRA GRAYER, Boca Raton, FL (US)

(21) Appl. No.: 15/241,046

(22) Filed: Oct. 7, 2016

Related U.S. Application Data
(60) Provisional application No. 62/208,294, filed on Aug. 21, 2015.

(51) Int. Cl. A61G 13/10; A47G 9/02

(52) U.S. Cl. CPC A61G 13/10; A47G 9/0284

(57) ABSTRACT

A polypropylene sheet with an upper panel and a lower panel that are joined at a foot end. The sheets are dimensioned to fit a person inside to protect them from direct contact with bedding sheets. There is an optional pillow pocket at the head end of the lower panel to fit a pillow inside also preventing direct contact. There are optional adhesive strips to seal one or both edges of the top panel to the bottom panel.

### II. BACKGROUND OF THE INVENTION

### 1. Field of the Invention

The present invention relates to bedding, and more particularly, to disposable sanitary bedding sheets.

### 2. Description of the Related Art

Several designs for sanitary furniture covering have been designed in the past. None of them, however, includes a breathable sheet suitable for travel made of breathable, non-woven polypropylene panels that resists tears and is silent during use.

Applicant believes that the closest reference relates to sanitary coverings used in medical examination rooms. However, it differs from the present invention because when used as sheets the present invention protects both the upper and lower sides of a person from sheets above and below the user. Further, the nature of using these sheets for hours at a time, possible over several days is benefitted by a more durable material found in a breathable non-woven polypropylene

Other patents describing the closest subject matter provide for a number of more or less complicated features that fail to solve the problem in an efficient and economical way. None of these patents suggest the novel features of the present invention.

### III. SUMMARY OF THE INVENTION

It is one of the main objects of the present invention to provide a low cost disposable sanitary bed sheet.

It is another object of this invention to provide a bed sheet suited for travel and hotel lodging.

It is still another object of the present invention to provide a bedding sheet that is durable and is easy to store and transport.

It is yet another object of this invention to provide such a device that is inexpensive to manufacture and maintain while retaining its effectiveness.

Further objects of the invention will be brought out in the following part of the specification, wherein detailed description is for the purpose of fully disclosing the invention without placing limitations thereon.

### IV. BRIEF DESCRIPTION OF THE DRAWINGS

With the above and other related objects in view, the invention consists in the details of construction and combination of parts as will be more fully understood from the following description, when read in conjunction with the accompanying drawings in which:

FIG. 1 shows a perspective view of a version of a disposable bed sheet.

FIG. 2 shows an elevation view of a disposable bed sheet.

FIG. 3 shows a partial plan view of a portion of a material.

FIG. 4 shows a perspective view of an example of a disposable bed sheet set up for use.

FIG. 5 shows a perspective view of a version of a disposable bed sheet.

### V. DETAILED DESCRIPTION OF THE PREFERRED EMBODIMENT

The subject device and method of use is sometimes referred to as the device, the invention, sheets, disposable bed sheets, machine or other similar terms. These terms may be used interchangeably as context requires and from use the intent becomes apparent. The masculine can sometimes refer to the feminine and neuter and vice versa. The plural may include the singular and singular the plural as appropriate from a fair and reasonable interpretation in the situation.

Referring now to the drawings, where the present invention is generally referred to with numeral 10, it can be observed that it basically includes a first panel 12, a second panel 14 and a fold 16.

One version of a disposable bed sheet is formed from a single panel of material doubled over at a fold 16. The first panel 12 is generally on an upper side and the second panel 14 is on a lower side.

The first panel 12 and second panel 14 can be roughly the same dimensions in one version of the device. In another version the second panel 14 may be than the first panel 12 to provide additional coverage under a pillow where the head of a user would typically rest during normal use.

FIGS. 1 and 2 show substantially the same embodiment of a disposable bed sheet. The fold 16 is at a foot end of the device. Opposite the fold 16 is a head end of the device. Between the head and foot ends the first panel 12 generally overlays the second panel 14. The width of the first panel 12 is similar to the width of the second panel 14 from the foot end to the head end.

The sides of the first panel 12 and second panel 14 can be attached along one or both edges from the foot end at the fold 16 towards the head end on either or both sides and fully or partially the span from the foot to the head. In this sense, one version of the disposable sheets have the first and second panels 12, 14 joined both at the foot at the fold 16 and along an edge. This would allow entry similar to how one would enter a camping sleeping bag zipped open along one edge.

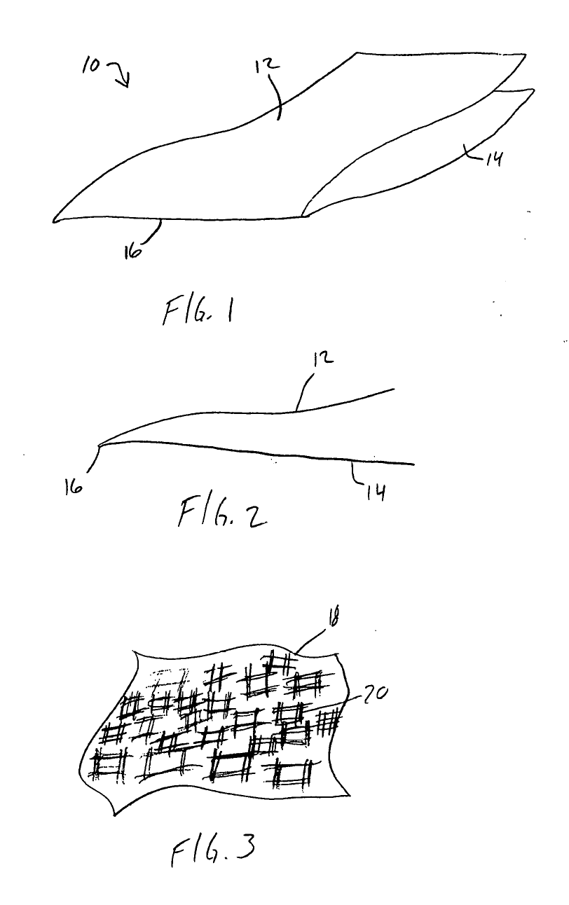

FIG. 3 shows a portion of a material 18 that the disposable bed sheets can be made from. This version of material 18 includes an embossing 20 to give the device a more flexible and softer feel on the skin as well as providing a decorative look. The embossing 20 may also provide improved air flow or insulation characteristics, depending on the pattern of the embossing.

The material 18 can optionally be formed of non-woven polypropylene fibers. The material 18 preferably is breathable to improve the comfort of the sleeper as the material 18 contacts their skin. Breathability will also prevent moisture buildup between the first panel 12 and second panel 14 from natural perspiration.

FIG. 4 is an example of a version of the device as it might be prepared prior to use and includes, among other features, a pillow 22 and a mattress 24.

In typical use the sheets and comforter provided on the bed are peeled back. The second panel 14 is spread out over the mattress 24. The first panel 12 is then spread out over the second panel 14. A pillow 22 is optionally placed at the head. A user of the device then slips between the first panel 12 and second panel 14 so that they do not make direct contact with the provided sheets.

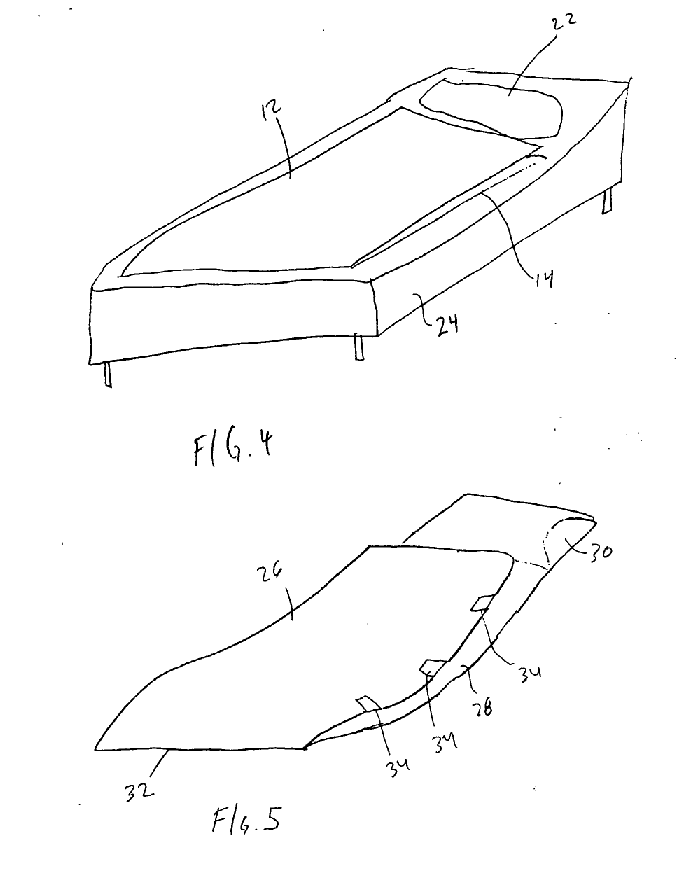

FIG. 5 shows another embodiment of a disposable bed sheet that includes, among other features, a third panel 26, a fourth panel 28, a pocket 30, a seam 32 and tabs 34. Similar to other designs an upper third panel 26 is spread out over a lower fourth panel 28. At a foot end the third panel 26 is connected to the fourth panel at a seam 32.

It will be appreciated by an average technician in the art that the seam 32 in the version of the device shown in FIG. 5 is analogous to the fold 16 in the version shown in FIG. 1. Either a seam or a fold is suitable to close the foot end of the device.

Tabs 34 are optionally provided along one or both edges of either the third panel 26 and/or fourth panel 28. The tabs 34 may manifest as an adhesive closure device that can selectively the secured to the corresponding edge to close up the interface between adjacent edges of the third panel 26 and second panel 28. The tabs 34 may be spaced periodically on the edges or may be comprised of a long adhesive strip to continuously seal an edge or both edges of the device.

As an alternative to the tabs 34, other closure means may be substituted, for example, hook and look fasteners, buttons, snaps, zippers or double channel locks (like those found on some reseal-able sandwich bags).

A pocket 30 is optionally provided on the head end of the fourth panel 28. The pocket 30 is dimensioned to accept a predetermined pillow. By this means the pillow can be isolated from contact with the head of the user.

The foregoing description conveys the best understanding of the objectives and advantages of the present invention. Different embodiments may be made of the inventive concept of this invention. It is to be understood that all matter disclosed herein is to be interpreted merely as illustrative, and not in a limiting sense.

What is claimed is:

1. Under circumstances where it is desired to provide sanitary bed sheets, or where bed sheets are unavailable, there is provided a device comprising a quantity of material that is arranged into two overlaying, disposable sheet panels, the device further comprising:
a) a first sheet panel of rectangular shape, having a left-side edge a right-side edge, a foot end, and a head end;
b) a second sheet panel of rectangular shape, having a left-side edge a right-side edge, a foot end, and a head end, whereby the left side and right side edges are of a length greater than the lengths of the left-side edge and right-side edge of the first sheet panel; and
c) a common junction at the respective foot ends of the first sheet panel and the second sheet panel, the junction manifesting as permanent fold, which fold results in an overlapping interface between the left-side edges of both sheet panels and the right-side edges of both sheet panels.

2. A device as in claim 1 wherein the material used consists of breathable non-woven polypropylene.

3. A device as in claim 1, wherein the first sheet panel and the second sheet panel are permanently attached along their respective left-side edges.

4. A device as in claim 1, wherein the first sheet panel and the second sheet panel are permanently attached along their respective right-side edges.

5. A device as in claim 1, wherein a pocket is fabricated at the head end of the second sheet panel, the pocket being of width, length and depth dimensions corresponding to the dimensions of a pillow.

6. Under circumstances where it is desired to provide sanitary bed sheets, or where bed sheets are unavailable, there is provided a device comprising a quantity of material that is arranged into two overlaying, disposable sheet panels, the device further comprising:
a) a first sheet panel of rectangular shape, having a left-side edge a right-side edge, a foot end, and a head end;
b) a second sheet panel of rectangular shape, having a left-side edge a right-side edge, a foot end, and a head end, whereby the left side and right side edges are of a length greater than the lengths of the left-side edge and right-side edge of the first sheet panel;
c) a pocket fabricated at the head end of the second sheet panel, the pocket being of width, length and depth dimensions corresponding to the dimensions of a pillow
d) a common junction at the respective foot ends of the first sheet panel and the second sheet panel, the junction manifesting as a permanent seam which seam results in an overlapping interface between the left-side edges of both sheet panels and the right-side edges of both sheet panels; and
e) a means of temporarily closing the interface between one edge of the first sheet panel and the corresponding edge of the second sheet panel.

7. A device as in claim 6 wherein the material used consists of breathable non-woven polypropylene.

8. A device as in claim 6 wherein the means of temporarily closing the interface between one edge of the first sheet panel and the corresponding edge of the second sheet panel consists of an adhesive strip attached length-wise along each of the respective edges.

9. A device as in claim 6 wherein the means of temporarily closing the respective interface between one edge of the first sheet panel and the corresponding edge of the second sheet panel consists of corresponding lengths of zippers attached length-wise along the left-side edge and the right-side edge of each the first sheet panel and the second sheet panel.

10. A device as in claim 6 wherein the means of temporarily closing the respective interface between one edged of the first sheet panel and the corresponding edge of the second sheet panel consists of a plurality of symmetrically-spaced tabs along the right-side edges and left-side edges of both sheets, the tabs consisting of correspondingly matched hook-and-felt closing mechanisms.

11. A device as in claim 6 wherein the means of temporarily closing the respective interface between one edge of the first sheet panel and the corresponding edge of the second sheet panel comprises a plurality of symmetrically-spaced tabs along the right-side edges and left-side edges of both sheets, the tabs consisting of correspondingly matched male and female snaps.

12. A device as in claim 6 wherein the means of temporarily closing the respective interface between one edge of the first sheet panel and the corresponding edge of the second sheet panel comprises a plurality of symmetrically-spaced tabs along the right-side edges and left-side edges of both sheets, the tabs consisting of double-channel self-sealing mechanisms.

13. Under circumstances where it is desired to provide sanitary bed sheets, or where bed sheets are unavailable, there is provided a device comprising a quantity of material that is arranged into two overlaying, disposable sheet panels, the device further comprising:
a) a first sheet panel of rectangular shape, having a left-side edge, a right-side edge, a foot end, and a head end;
b) a second sheet panel of rectangular shape, having a left-side edge, a right-side edge, a foot end, and a head end, whereby the left side and right side edges are of a length greater than the respective lengths of the left-side edge and right-side edge of the first sheet panel;
c) a pocket fabricated at the head end of the second sheet panel, the pocket being of width, length and depth dimensions corresponding to the dimensions of a pillow;
d) a common junction at the respective foot ends of the first sheet panel and the second sheet panel, the junction manifesting as a permanent seam which results in an overlapping interface between the left-side edges of both sheet panels and the right-side edges of both sheet panels; and
e) a means of temporarily closing the respective interfaces between the left-side edges of the first sheet panel and the second sheet panel and the right-side edges of the first sheet panel and the second sheet panel.

14. A device as in claim 13 wherein the material used consists of breathable non-woven polypropylene.

15. A device as in claim 13 wherein the means of temporarily closing the respective interface between the left-side edges of both sheet panels and the interface between the right-side edges of both sheet panels consists of an adhesive strip attached length-wise along the left-side edge and the right-side edge of each the first sheet panel and the second sheet panel.

16. A device as in claim 13 wherein the means of temporarily closing the respective interface between the left-side edges of both sheet panels and the interface between the right-side edges of both sheet panels consists of corresponding lengths of zippers attached length-wise along the left-side edge and the right-side edge of each the first sheet panel and the second sheet panel.

17. A device as in claim 13 wherein the means of temporarily closing the respective interface between the left-side edges of both sheet panels and the interface between the right-side edges of both sheet panels consists of a plurality of symmetrically-spaced tabs along the right-side edges and left-side edges of both sheets, the tabs consisting of correspondingly matched hook-and-felt closing mechanisms.

18. A device as in claim 13 wherein the means of temporarily closing the respective interface between the left-side edges of both sheet panels and the interface between the right-side edges of both sheet panels consists of a plurality of symmetrically-spaced tabs along the right-side edges and left-side edges of both sheets, the tabs consisting of correspondingly matched male and female snaps.

19. A device as in claim 13 wherein the means of temporarily closing the respective interface between the left-side edges of both sheet panels and the interface between the right-side edges of both sheet panels consists of a plurality of symmetrically-spaced tabs along the right-side edges and left-side edges of both sheets, the tabs consisting of double-channel self-sealing mechanisms.
